(19) United States
(12) Patent Application Publication
(10) Pub. No.: US 2012/0200566 A1
(43) Pub. Date: Aug. 9, 2012

(54) SYSTEM AND METHOD FOR MESH REFINEMENT

(75) Inventors: Andrey Chernikov, Virginia Beach, VA (US); Nikos Chrisochoides, Williamsburg, VA (US)

(73) Assignee: Old Dominion University Research Foundation, Washington, DC (US)

(21) Appl. No.: 13/311,289

(22) Filed: Dec. 5, 2011

Related U.S. Application Data
(60) Provisional application No. 61/419,603, filed on Dec. 3, 2010.

(51) Int. Cl. G06T 17/00

(52) U.S. Cl. 345/420

(57) ABSTRACT

A method for generating and refining meshes for a three-dimensional domain. The method includes generating a initial Delaunay mesh; identifying selection balls whose radius-edge ratio is greater than an upper bound value; and refining the generated Delaunay mesh by inserting points within the selection balls to reduce the radius-edge ratios of all tetrahedral in the mesh below a given upper bound value. Selection balls include one-dimensional selection balls, two-dimensional selection balls, and three-dimensional selection balls. The selection balls of a lower dimension are refined before the selection balls of a higher dimension are refined.

### RELATED APPLICATION

This application claims priority to Provisional Application No. 61/419,603 filed on Dec. 3, 2010, the entirety of which is incorporated herein by reference.

### BACKGROUND

Delaunay refinement is a popular automatic mesh generation and refinement method which generates and refines meshes by present algorithms and at the same time ensures termination and good grading. Mesh generation by Delaunay refinement is a widely used technique for constructing guaranteed quality triangular and tetrahedral meshes. The quality guarantees are usually provided in terms of the bounds on circumradius-to-shortest edge ratio and on the grading of the resulting mesh. Traditionally circumcenters of skinny elements and middle points of boundary faces and edges are used for the positions of inserted points. Delaunay refinement is very useful for parallel and/or time critical applications when human intervention and reruns are prohibitively time consuming.

Delaunay refinement algorithms are based on the method of inserting new points into the mesh to improve the aggregate quality of elements (triangles in two dimensions or tetrahedra in three dimensions). Quality is traditionally defined as the ratio of the circumradius of the element to the length of its shortest edge [7, 9, 13, 19, 21]. The use of this measure leads to the improvement of the minimum angle in two dimensions which helps to improve the conditioning of the stiffness matrix used by a field solver. In three dimensions this measure does not yield such direct benefits, however, it has been shown [13] that bounded circumradius-to-shortest edge ratio of mesh elements is sufficient to obtain optimal convergence rates for the solution of Poisson equation using the control volume method. The analysis and rigorous proofs of Delaunay refinement were pioneered by Ruppert [19] and Chew [6], and further developed by Shewchuk [20, 21].

One of the central questions in the Delaunay refinement method has been the choice of the positions for the new points. The traditional approach uses circumcenters of mesh elements, however, a number of other locations have been used to achieve various mesh optimizations [3, 7, 10, 11, 17, 23].

### SUMMARY

According to an embodiment, disclosed is a general framework for the parallelization of multiple variations of sequential Delaunay refinement algorithms. One-, two-, and three-dimensional selection regions (all in the same three-dimensional space) are defined such that any variation of a Delaunay refinement algorithm which inserts new points in these regions is guaranteed to terminate and to produce a well graded mesh. As a result, the parallelization of the generalized algorithm automatically implies the parallelization of each individual variation.

According to an embodiment, the present disclosure is directed to a method for generating and refining meshes for a three-dimensional domain. The method includes generating a initial Delaunay mesh; identifying selection balls whose radius-edge ratio is greater than an upper bound value; and refining the generated Delaunay mesh by inserting points within the selection balls to reduce the radius-edge ratios of all tetrahedra in the mesh below a given upper bound value. Selection balls include one-dimensional selection balls, two-dimensional selection balls, and three-dimensional selection balls. The selection balls of a lower dimension are refined before the selection balls of a higher dimension are refined.

According to another embodiment, the predetermined amounts include a first value for a one-dimensional reduction, a second value for a two-dimensional reduction, and a third value for a three-dimensional reduction.

According to another embodiment, the product of the first value, the second value, and the third value is greater than one to ensure a termination of the refining process.

According to another embodiment, disclosed is a recording medium storing a program that instructs a computer to generate and refine meshes for a three-dimensional domain, the program includes instruction in accordance with the method as set forth in the present disclosure.

### BRIEF DESCRIPTION OF DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates functional modules of a computer according to an embodiment.

FIG. 2 illustrates a Bowyer-Watson point insertion algorithm according to an embodiment.

FIG. 3a illustrates a one-dimensional selection ball according to an embodiment.

FIG. 3b illustrates a two-dimensional selection ball according to an embodiment.

FIG. 3c illustrates a three-dimensional selection ball according to an embodiment.

FIG. 4 illustrates a proof of Theorem 4.1 according to an embodiment.

FIG. 5a illustrates an example of the mutual position of tetrahedron and a triangular face with three shared vertices according to an embodiment.

FIG. 5b illustrates an example of the mutual position of tetrahedron and a triangular face with two shared vertices according to an embodiment.

FIG. 5c illustrates an example of the mutual position of tetrahedron and a triangular face with 1 shared vertices according to an embodiment.

FIG. 5d illustrates an example of the mutual position of tetrahedron and a triangular face with zero shared vertices according to an embodiment.

FIG. 6a illustrates a part of the proof of Theorem 4.1 according to an embodiment.

FIG. 6b illustrates another part of the proof of Theorem 4.1 according to an embodiment.

FIG. 7a illustrates a part of the proof of Lemma 4.2 according to an embodiment.

FIG. 7b illustrates another part of the proof of Lemma 4.2 according to an embodiment.

FIG. 8 illustrates a relationship between the insertion radius of a vertex and the insertion radius of its parent within a single parent sequence according to an embodiment.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially or and “consists essentially of have the meaning ascribed to them in U.S. patent law; that is, they allow for elements not explicitly recited, but exclude elements that are found in the prior art or that affect a basic or novel characteristic of the invention. Embodiments of the present invention are disclosed or are apparent from and encompassed by, the following description.

Existing algorithms are limited by a small number of fixed locations for the insertion of new points. The disclosed system and method allow substantially more points to be inserted than the existing algorithms. The sets of locations to have insertions are referred to as selection balls herein. These selection balls are defined over all of the following types of spaces that define the three-dimensional mesh generation space: one-dimensional edges of the input geometry, two-dimensional faces of the input geometry, and three-dimensional volume of the input geometry.

The method as set forth in the present disclosure can be used for the development of new guaranteed quality sequential and parallel Delaunay mesh refinement algorithms. One advantage includes the fact that significant effort can be saved on the theoretical analysis of the each specific point placement approach as long as it fits the proposed general framework, since the analysis has been done for the general framework. This analysis covers the properties of the algorithms, i.e. fidelity, termination, and good grading guarantees.

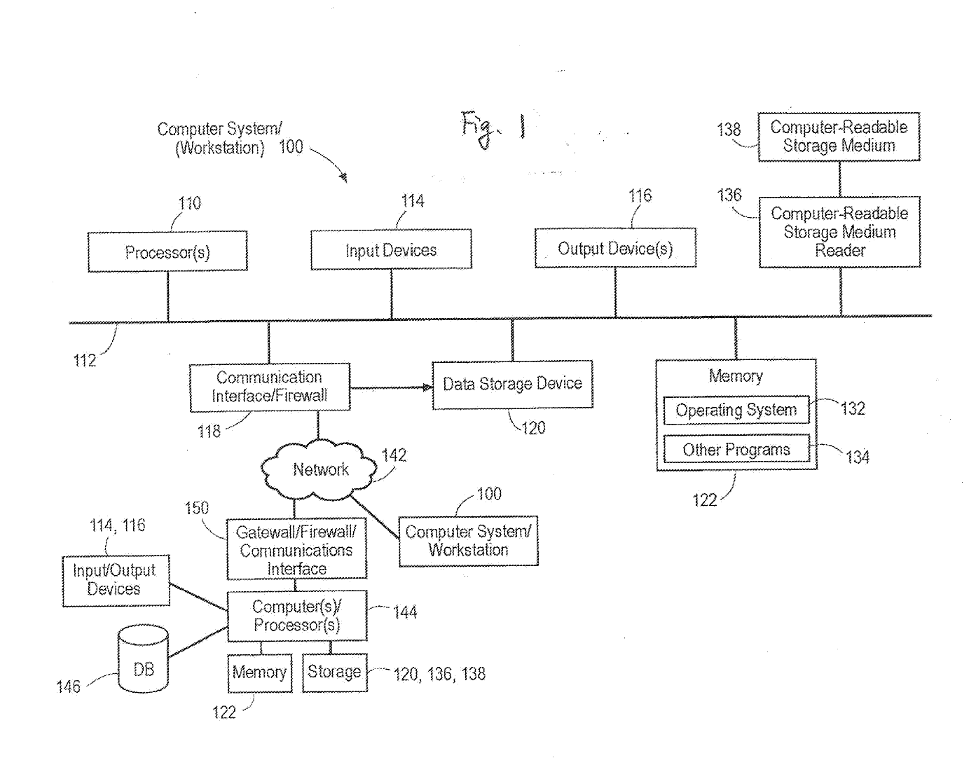

Embodiments can be implemented by a programmable digital computer or a system using one or more programmable digital computers and computer readable storage media. In one embodiment, FIG. 1 depicts an example of one such computer system 100, which includes at least one processor 110, such as, e.g., an Intel or Advanced Micro Devices microprocessor, coupled to a communications channel or bus 112. The computer system 100 further includes at least one input device 114 such as, e.g., a keyboard, mouse, touch pad or screen, or other selection or pointing device, at least one output device 116 such as, e.g., an electronic display device, at least one communications interface 118, at least one computer readable medium or data storage device 120 such as a magnetic disk or an optical disk and memory 122 such as Random-Access Memory (RAM), each coupled to the communications channel 112. The communications interface 118 may be coupled to a network 142.

One skilled in the art will recognize that any variations of the system 100 are possible, e.g., the system 100 may include multiple channels or buses 112, various arrangements of storage devices 120 and memory 122, as different units or combined units, one or more computer-readable storage medium (CRSM) readers 136, such as, e.g., a magnetic disk drive, magneto-optical drive, optical disk drive, or flash drive, multiple components of a given type, e.g., processors 110, input devices 114, communications interfaces 118, etc.

In one or more embodiments, computer system 100 communicates over the network 142 with at least one computer 144, which may comprise one or more host computers and/or server computers and/or one or more other computers, e.g. computer system 100, performing host and/or server functions including web server and/or application server functions. In one or more embodiments, a database 146 is accessed by the at least one computer 144. The at least one computer 144 may include components as described for computer system 100, and other components as is well known in the computer arts. Network 142 may comprise one or more LANS, WANS, intranets, the Internet, and other networks known in the art. In one or more embodiments, computer system 100 is configured as a workstation that communicates with the at least one computer 144 over the network 142. In one or more embodiments, computer system 100 is configured as a client in a client-server system in which the at least one other computer comprises one or more servers. Additional computer systems 100, any of which may be configured as a work station and/or client computer, may communicate with the at least one computer 144 and/or another computer system 108 over the network 142.

The present disclosure sets forth a method that includes multiple custom point placement techniques by means of defining special regions, such that any Delaunay refinement-based technique which places points in these regions will automatically have termination and good grading guarantees. Then the development of parallel versions of all these techniques is reduced to the parallelization of this single generalized approach [4].

Two-dimensional and three-dimensional point insertion methods and suggested use of two-dimensional and three-dimensional regions, respectively are described in [3] ANDREY N. CHERNIKOV AND NIKOS P. CHRISOCHOIDES, Three-dimensional semi-generalized point placement method for Delaunay mesh refinement, in Proceedings of the 16th International Meshing Roundtable, Seattle, Wash., October 2007, Springer, pp. 25-44, the entirety of which is incorporated by reference hereby. These regions were defined for the highest dimension, and, hence, the approach it termed semi-generalized. A fully generalized approach for two dimensions, i.e., defining the selection regions for both one-dimensional elements (segments) and two-dimensional elements (triangles), as disclosed in [5] Generalized two-dimensional Delaunay mesh refinement, SIAM Journal on Scientific Computing, 31 (2009), pp. 3387-3403, the entirety of which is incorporated by reference hereby. A constrained Delaunay approach to improve the angle bound and to extend the selection regions in two dimensions is disclosed in [8] PANAGIOTIS A. FOTEINOS, ANDREY N. CHERNIKOV, AND NIKOS P. CHRISOCHOIDES, Fully generalized two-dimensional constrained Delaunay mesh refinement, SIAM Journal on Scientific Computing, 32 (2010), pp. 2659-2686] the entirety of which is incorporated by reference hereby. Disclosed herein is the development of a three-dimensional fully generalized algorithm which utilizes selection regions simultaneously for one-, two-, and three-dimensional elements. The technique offers the following contributions:

A novel three-dimensional fully generalized Delaunay refinement algorithm is formulated.

The geometric fidelity of the meshes produced by this algorithm, i.e., that new points are always inserted inside the domain is proved.

It is proved that this algorithm terminates, and moreover produces well graded meshes.

In this disclosure disclosed is a general approach to the selection of point positions by defining one-, two-, and three-dimensional selection regions such that any point insertion strategy based on these regions automatically has certain guarantees proven here. In particular, for the input models defined by planar linear complexes under the assumption that no input angle is less than 90°, is proved that the termination of the proposed generalized algorithm, as well as fidelity and good grading of the resulting meshes.

Basic Considerations. Consider the input domain Ω described by a Planar Linear Complex (PLC) [7,9, 14, 19, 21]. A PLC χ consists of a set of vertices, a set of straight line segments, and a set of planar facets. χ describes a nonconvex bounded polyhedral domain with holes. Each element of χ is considered constrained and is preserved during the construction of the mesh, although it can be subdivided into smaller elements through the insertion of new vertices. The vertices of χ also represent a subset of the final set of vertices in the mesh.

Let the mesh Mχfor the given PLC χ consist of a set V of vertices and a set T of tetrahedra formed on the vertices from V. To measure the quality of a tetrahedron t, follow the traditional approach [7, 9, 14, 19, 21] and use the circumradius-to-shortest edge ratio, or radius-edge ratio for short, which is denoted as ρ(t). The algorithm takes as input an upper bound ρ̅≧2 on radius-edge ratio and outputs a mesh with all tetrahedra satisfying this bound. The tetrahedra that violate this bound is called skinny.

Consider an n-simplex ξ (n=1, 2, 3) embedded in three dimensions, which is a straight line segment, a triangular face, or a tetrahedron. Call the open ball corresponding to the smallest sphere which passes through the vertices of ξ the circumball of ξ. The center of the circumball is called the circumcenter of the element,

DEFINITION 2.1 (Delaunay simplex [20]). An edge, triangular face, or tetrahedron whose vertices are members of V is said to be Delaunay if there exists an empty sphere that passes through all of its vertices.

Here a sphere is considered empty if it does not contain any of mesh vertices in its interior; however, parts of edges and faces are allowed.

If all simplices in a 3D mesh are Delaunay, then the whole mesh is said to satisfy the Delaunay property. Moreover, all the 2D meshes of the PLC facets are also Delaunay in their respective planes.

Traditional Delaunay mesh generation algorithms start with the construction of the initial mesh, which conforms to χ, and then refine this mesh until it has no more skinny tetrahedra. The general idea of Delaunay refinement is to insert additional (so-called Steiner) points inside the circumballs of skinny tetrahedra, which leads to their removal, until they are gradually eliminated and replaced by better quality tetrahedra.

The notion of cavity [9] which is the set of tetrahedra in the mesh whose circumballs include a given point v is used herein. Denote C _{T}(V) to be the cavity of v with respect to the set of tetrahedra T and ∂C_{T}(v) to be the set of triangles that form the boundary of the cavity, i.e., the triangles which belong to only one tetrahedron in C_{T}(v). Use the Bowyer-Watson (B-W) point insertion algorithm [2, 24], which can be written shortly as follows.

```
BOWYERWATSON( [symbol]  , v)
Input: [symbol]  = (Vⁿ,Tⁿ) is the mesh of PLC X at time step n before the
insertion of v
Output: [symbol]  = (Vⁿ⁺¹,Tⁿ⁺¹) after the insertion of v
1: Vⁿ⁺¹ ← Vⁿ ∪ {v}
2: Tⁿ⁺¹ ← Tⁿ \ C_{T}ⁿ (v) ∪ {(vξ) | ξ ε ∂C_{T}ⁿ (v)}
      // Hero (vξ) is the tetrahedron obtained by connecting vertex v
      // to the vertices of triangle ξ.
```

Delaunay refinement algorithms observe special encroachment rules. In particular, if a Steiner point v is considered for insertion, but it lies within the circumball of a constrained subfacet ξ, v is not inserted but a point on the facet containing ξ is inserted instead. Similarly, if v is inside the circumball of a constrained subsegment, then a point inside this subsegment is inserted instead. In contrast to faces and edges, there can be no encroached vertices.

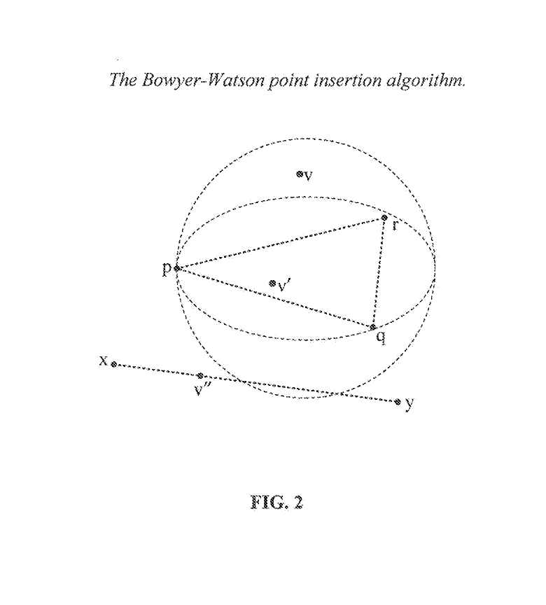

As shown in the example in FIG. 2, the new Steiner point v can lie inside the circumball of a constrained face pqr. In this case, v is rejected and the algorithm attempts to insert point v′ in the facet containing triangle pqr. If v′ does not encroach upon any constrained subsegments, it is inserted into the mesh. If, however, it encroaches upon a constrained subsegment, which is xy in the example, v′ is also rejected and point v″in xy is inserted. With each boundary face, associate an inside and an outside normal vector. Also, for each tetrahedron, consider its centroid, which is inside both the tetrahedron and the domain. If v is a point chosen to remove a skinny tetrahedron 1, then a boundary face is considered encroached upon by v if and only if v is inside the circumball of and the centroid of t is towards the inside direction of ξ. Similar rules are used for other encroachment instances.

These encroachment rules serve two related goals: (1) to preserve all of the sub-features of the PLC in the Delaunay mesh by means of ensuring they have empty spheres passing through their vertices (the smallest such sphere is chosen—the one corresponding to the circumball).; (2) to ensure that inserted Steiner vertices are inside the mesh domain Ω (as can be seen from Theorem 4.1). The following algorithm shows the logic behind point insertion and rejection.

| POINTINSERTION(X, [symbol] , v) | |
|---|---|
| Input: | X is the input PLC |
| | [symbol] is a Delaunay mesh of X before the insertion of v |

Output: [symbol] after the insertion or the rejection of v
1: if v encroaches upon some constrained subsegments
2: Mark one of these subsegments as encroached
3: elseif v encroaches upon some constrained subfaces
4: Mark the subface containing the projection of v as encroached
5: else
6: BOWYERWATSON( [symbol] , v)
7: endif

To make the proof of termination possible, Delaunay refinement needs to avoid infinite encroachment sequences. To prevent infinite encroachment on adjacent features, follow the previous approaches and make a simplifying assumption that there are no angles less than 90° between adjacent features of the PLC. As a result, no point on one of the PLC features, say ξ, can be inside the circumball of an adjacent PLC feature, say ξ′, independently of where the point is located in a selection ball defined in ξ.

A common approach for dealing with small input angles includes isolating the regions around them and meshing their neighborhood with a predefined pattern. Bern, Eppstein, and Gilbert [1] cut off the acute interior angles by creating isosceles triangles at their apex vertices. Mitchell and Vavasis [15] in the context of their octree-based algorithm enclose such angles in protected boxes which are triangulated in a specific way. Ruppert [19] describes how to use circles with radius equal to a fraction of the local feature size to shield vertices at sharp interior angles by creating triangles around these vertices. Rand and Walkington [16] extend this approach to three-dimensional Delaunay refinement by using two types of protective regions, so-called collars and intestines. Miller, Pav, and Walkington [12] developed a variation of Ruppert's algorithm which allows for a larger angle bound by introducing a special rule for treating skinny triangles across from input angles.

DEFINITION 2.2 (Local feature size [21]). The local feature size function lfs(v) for a given point v is equal to the radius of the smallest ball centered at v that intersects two non-incident elements of the PLC. The lfs ( ) function satisfies the Lipschitz condition:

LEMMA 2.3 (Lipschitz condition, Lemma 2 in [21]). Given any PLC and any two points u and v, the following inequality holds:

lfs(v)≦lfs(u)+lu−vl. (2.1)

The standard Euclidean norm ∥∥ is used throughout the disclosure,

The traditional proofs of termination and of good grading of Delaunay refinement algorithms explore the relationships between the insertion radius of a point and that of its parent. Stated shortly, the insertion radius of point v is the length of the shortest edge connected to v, and the parent is the vertex which is “responsible” for the insertion of v [21].

DEFINITION 2.4 (Insertion radius [21]). The insertion radius R(v) of point v is the length of the shortest edge which would be connected to v if v is inserted into the mesh, immediately after it is inserted.

The following definition of a parent vertex generalizes the corresponding definition in [21]. In the analysis herein, even though the child is not necessarily the circumcenter of an encroached subfacet or subsegment, the parent is still defined to be the same vertex.

DEFINITION 2.5 (Parent of a Steiner vertex). The parent \hat{v}, of vertex v is the unique vertex which is defined as follows:

If v is an input vertex, it has no parent,

If v lies on an encroached subsegment or subfacet ξ, then \hat{v} is the earliest detected point (possibly rejected for insertion) encroaching upon ξ.

If v is inserted to remove a chosen skinny tetrahedron t, \hat{v} is the most recently inserted vertex of the shortest edge of t.

Generalized Delaunay Refinement: This section begins by introducing the definitions and the analysis tools that allow Steiner vertices to be inserted in arbitrary positions within so-called selection balls. The section concludes by describing the complete algorithm.

DEFINITION 3.1 (Typed vertex). A vertex in three-dimensional space is considered of Type-0, Type-1, Type-2, or Type-3 if it is an input vertex, lies on an input segment, lies on an input planar face, or none of the above, respectively.

DEFINITION 3.2 (Selection ball). For a d-simplex ξ with circumcenter c and circumradius r, under one of the following conditions:

d=1; or

d=2; or

d=3, the shortest edge length of ξ is equal to 1, and the radius-edge ratio

ρ=r/l≧ ρ̅≧2;

the selection ball of ξ is the closed d-ball with center c and radius r(1−δ_{d}) in the hyperplane defined by ξ (line, plane, or 3D space), where δ_{d} (d=1, 2,3) are constant parameters chosen such that

$${δ}_{1} {δ}_{2} {δ}_{3} \geq \frac{2}{\overline{ρ}} , {δ}_{1} \leq 1 , {δ}_{2} \leq 1 , {δ}_{3} \leq 1. \qquad ( 3.1 )$$

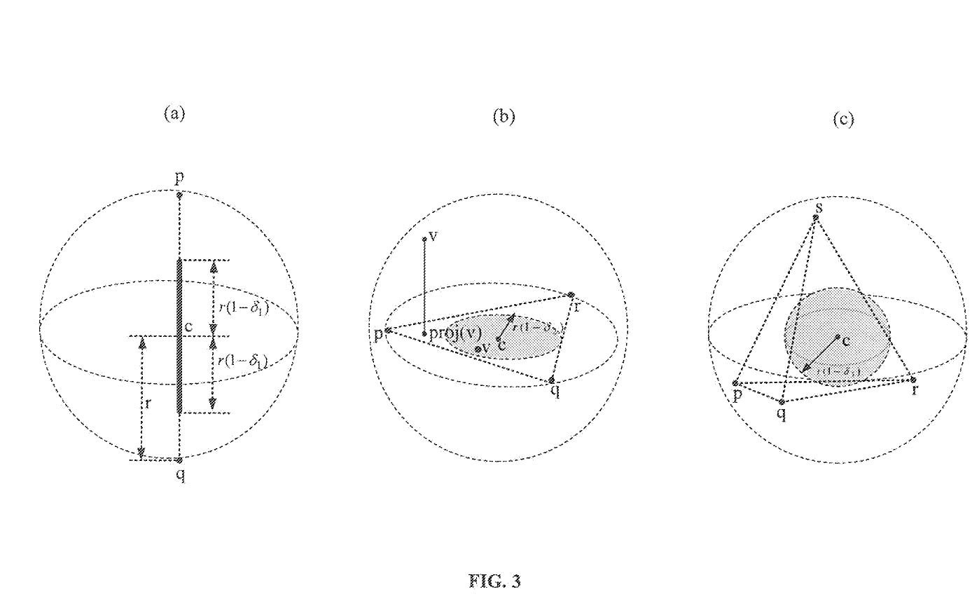

The above description has been illustrated in FIGS. 3a, 3b, and 3c.

The inequality limiting the product in (3.1) arises from the requirement imposed by the termination condition, i.e., that the algorithm does not create a sequence of ever shorter edges. As can be seen later, in the worst case a new edge length is a multiple of δ₁/\sqrt{2}·δ₂/\sqrt{2}·δ₃ ρ̅ of some existing edge length, and this multiplier needs to be greater than or equal to one.

DEFINITION 3.3 (Originating vertex). The originating vertex is an inserted (i.e., not rejected) vertex of Type-d (d=0, 1, 2) which either has no parent or has a parent of Type-k (k=0, 1, 2) which lies on a PLC feature non-adjacent to the one containing this vertex.

For example, all vertices of the PLC satisfy the definition of an originating vertex since they are inserted into the mesh (before the Delaunay refinement phase) and have no parents.

The following definition is adapted and modified from [22].

DEFINITION 3.4 (Parent sequence). The parent sequence of a vertex v=v₁ is a sequence of vertices {vₗ}^{m}i=₁, such that all of the following conditions hold:

(i) v₁ can be a vertex of any type,

(ii) vᵢ₊₁ is the parent of vᵢ, for i=1, . . . , m−1,

(iii) vₘ is an originating vertex.

The complete Generalized Delaunay Refinement algorithm is presented in the following:

GENERALIZEDDELAUNAYREFINE [symbol] ENT(X, ρ̅, δ₁, δ₂, δ₃, κ₁( ), κ₂( ), κ₃( ), [symbol] )

| | |
|---|---|
| Input: | X is the PLC which encloses the domain Ω |
| | ρ̅ is the upper bound on radius-edge ratio, ρ̅ ≧ 2 |
| | δ₁, δ₂, δ₃ are the parameters that define selection regions, sec (3.1) |
| | κ₁( ), κ₂( ), κ₃( ) are user-defined functions which return specific positions |
| | for Steiner points within respective selection balls |
| | [symbol] = (V,T) is an initial Delaunay mesh of X, where V is the set of vertices |
| | and T is the set of tetrahedra |

Output: A refined Delaunay mesh [symbol] which respects the bound ρ̅

| | |
|---|---|
| 1: | Let ENCROACHEDSEG [symbol] ENTS( ) return the current set of encroached subsegments |
| 2: | Let ENCROACHEDFACES( ) return the current set of encroached triangular subfaces |
| 3: | Let SKINNYTETRAHEDRA( ) return the current set of skinny tetrahedra in T |
| 4: | while (ENCROACHEDSEG [symbol] ENTS( )≠ or |
| | ENCROACHEDFACES( )≠ or |
| | SKINNYTETRAHEDRA( )≠ ) |
| 5: | if ENCROACHEDSEG [symbol] ENTS( )≠ |
| 6: | Pick s ∈ ENCROACHEDSEG [symbol] ENTS( ) |
| 7: | v ← κ₁(δ₁, s) |
| 8: | POINTINSERTIONS(X, [symbol] , v) |
| 9: | elseif ENCROACHEDFACES( )≠ |
| 10: | Pick f ∈ ENCROACHEDFACES( ) |
| 11: | v ← κ₂(δ₂, f) |
| 12: | POINTINSERTION(X, [symbol] , v) |
| 13: | elseif SKINNYTETRAHEDRA( )≠ |
| 14: | Pick t ∈ SKINNYTETRAHEDRA( ) |
| 15: | v ← κ₃(δ₃, t) |
| 16: | POINTINSERTION(X, [symbol] , v) |
| 17: | endif |
| 18: | endwhile |

Proof of Fidelity: In this section it is proved that the algorithm maintains geometric fidelity to the domain Ω, in other words, all Steiner vertices are inserted inside Ω. The following theorem shows that the use of encroachment rules prevents Steiner points from being inserted outside Ω. In other words, a point is either encroaching and rejected, or inside Ω.

THEOREM 4.1 Let t be a d-dimensional simplex of a d-dimensional Delaunay mesh (d=2, 3) of domain Ω bounded by a set Γ of (d−1)-dimensional simplices. Let v be an arbitrary point inside the d-dimensional circumball of t. Then either v E Ω, or v encroaches upon some (d−1)-dimensional simplex ξ ∈ Γ.

A proof is presented for 3D, and the 2D case.

The proof is by contradiction. For the sake of contradiction, assume that v is outside of Ω and does not encroach upon any of the boundary triangles. Below it is shown that under this assumption at least one mesh vertex is inside the circumball of t, and therefore there is a contradiction with the Delaunay property.

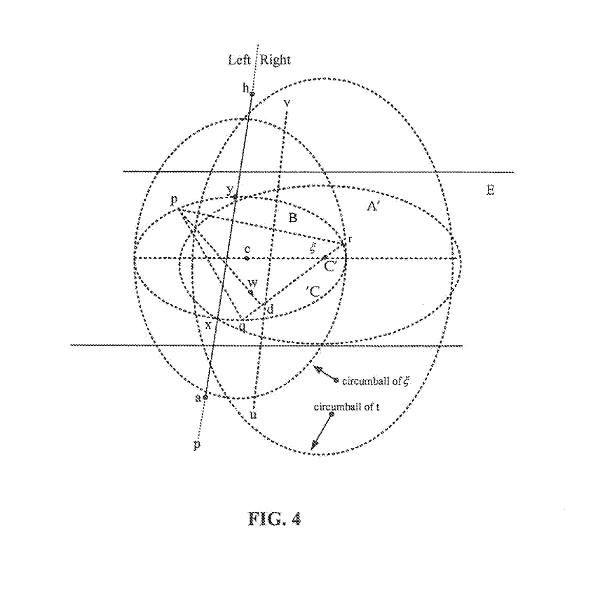

Let u be an arbitrary vertex of t, and let w be the point of intersection of the straight line segment uv with the boundary Γ, see FIG. 4.1. There are three intersection cases:

(A1) if w falls onto one of the mesh vertices, let q=w be this vertex, and let ξ be one of the boundary triangles with vertex o and other two vertices p and r.

(A2) If w falls onto a mesh edge, let pq be this edge, ξ be one of the boundary faces with edge pq, and r be the third vertex of ξ.

(A3) Otherwise, w has to fall strictly inside some boundary face. Let be this boundary face with vertices p, q, and r.

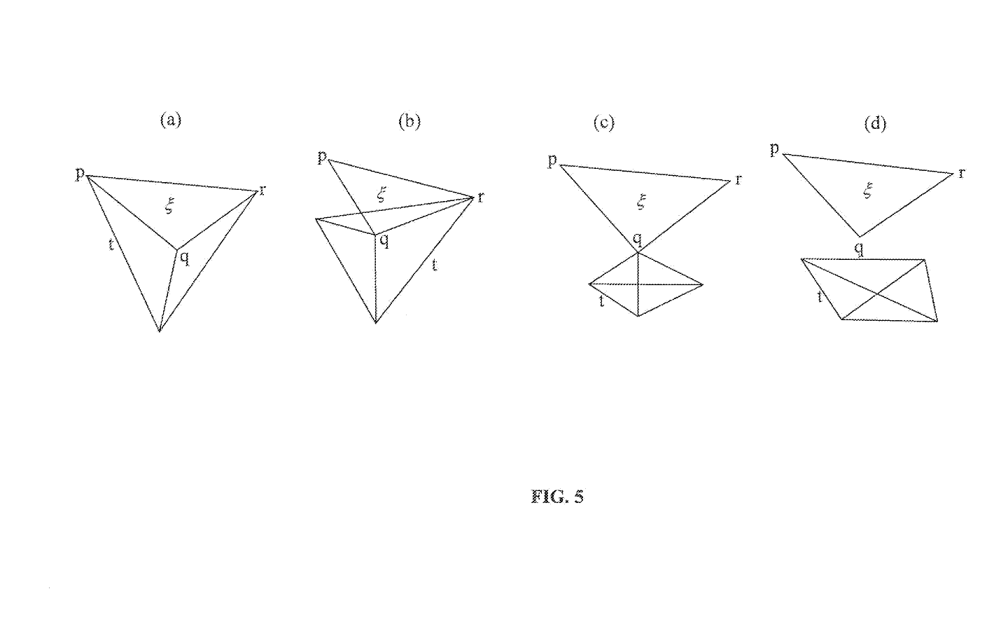

In FIGS. 5a, 5b, 5c, and 5d, described are examples of the mutual position of t and.

Let Ξ be the plane defined by ξ. Consider two circles: (1) open circle A′ with center C′ and radius R′, which is the intersection of with the circumball of t (C is the circumcenter of t); and (2) open circle B with center c and radius r, which is the circumscribed circle of triangle ξ. These two circles lie in the same plane by construction.

If c=C′, two cases are considered:

(B1) If r<R′, vertices p, q, and r must be inside the circumball of t, and the proof is finished.

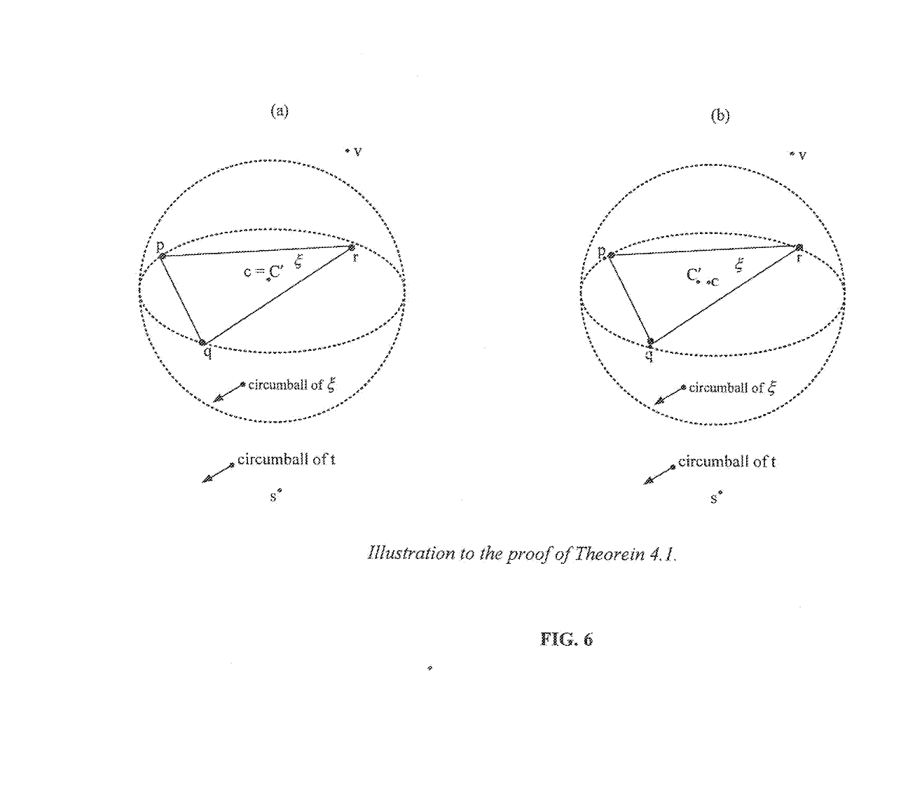

(B2) If r≧R′, consider two subcases:
(B2-a) Suppose u=w (and therefore from (A1)) w=q). At least one vertex (say, s) oft must be distinct from p, q, and r. s must be outside of the circumball of ξ due to the encroachment rules and on the other side of Ξ from v since t is inside Ω. Then v clearly cannot be inside the circumball of t, see FIG. 6a,
(B2-b) If u≠6 w, the argument is the same as in the previous subcase (with u instead of s), and this subcase is also not possible.

Therefore, for the rest of the proof, assume that c≠C′.

For the clarity of presentation FIG. 4 is drawn such that the straight line cC′ is parallel to the view plane. Because of this orientation, the circle at the intersection of the circumballs of t and of ξ is perpendicular to the view plane and is represented in the figure as a straight line segment, ab. The plane defined by this circle is denoted as P, and the partition of space induced by P as “left” and “right”.

If all three vertices p, q, r are inside A′, they are also inside the circumball of t, and the proof is finished. Otherwise, without loss of generality assuming p is outside of A′, it is shown that both q and r cannot be outside of A′, and therefore at least one of the vertices q and r must be inside the circumball of t. Consider the straight line defined by points p and w (p≠6 w by construction, see (A1)-(A3)). Since w is inside, this line intersects segment qr at some point, say d. (As special cases, d=q and w=d=q.) Now the following facts are stated:

(C1) p is outside of A′ by assumption.

(C2) p is to the left of or on P, as follows from construction and (C1).

(C3) v is to the right of P, since it is inside the circumball of t and outside of the circumball of ξ

(C4) u is to the right of or on F, as it is on the boundary of t's circumball (being a vertex of t) and outside of the circumball of ξ (by the encroachment rules).

(C5) w is to the right of P, as follows from construction, (C3) and (C4).

(C6) d is to the right of P, as follows from construction, (C2) and (C5),

(C7) w is inside of A′ because v is inside the circumball of t, and u is inside or on the boundary of the circumball of t.

(C8) w is inside or on the boundary of B because it is inside or on the boundary of ξ.

Based on these point positions, noting that (C7) and (C8) imply that A′ and B intersect, three configurations for the intersection of A′ and B are considered:

(D1) A′ and B are exactly equal. This case is not possible since c ≠6 C′.

(D2) Boundaries of A′ and of B touch in a single point p while A′ is inside B. By the argument similar to case (B2), this case is also not possible, see FIG. 6b.

(D3) Boundaries of A′ and of B intersect in exactly two distinct points, x and y, and each of these two points may or may not be equal to p. Since part of the circle B which is on the right side from P is completely inside A′, from (C6) it follows that at least one of the points q and r has to be to the right of P, and therefore both inside A′ and inside the circumball of t.

Proof of Termination. In this section, it is proved that the termination of the GENERALIZED DELAUNAY REFINEMENT algorithm. The underlying idea of the analysis is to show that the length of the mesh edges created by the algorithm is bounded from below by a constant which only depends on the input PLC.

First, recall the following lemma.

LEMMA 5.1 (Projection Lemma [21]). Let f be a subfacet of the Delaunay tri-angulated facet F. Suppose that f is encroached upon by some vertex v, but v does not encroach upon any subsegment of F. Then proj_{F}(v) lies in the facet F, and v encroaches upon a subfacet of F that contains proj_{F}(v).

Note that this lemma requires that subsegment encroachment is resolved before subfacet encroachment. This requirement is satisfied in the formulation of the GENERALIZED DELAUNAY REFINEMENT algorithm herein.

Now the following two lemmas that will be used later on are proved.

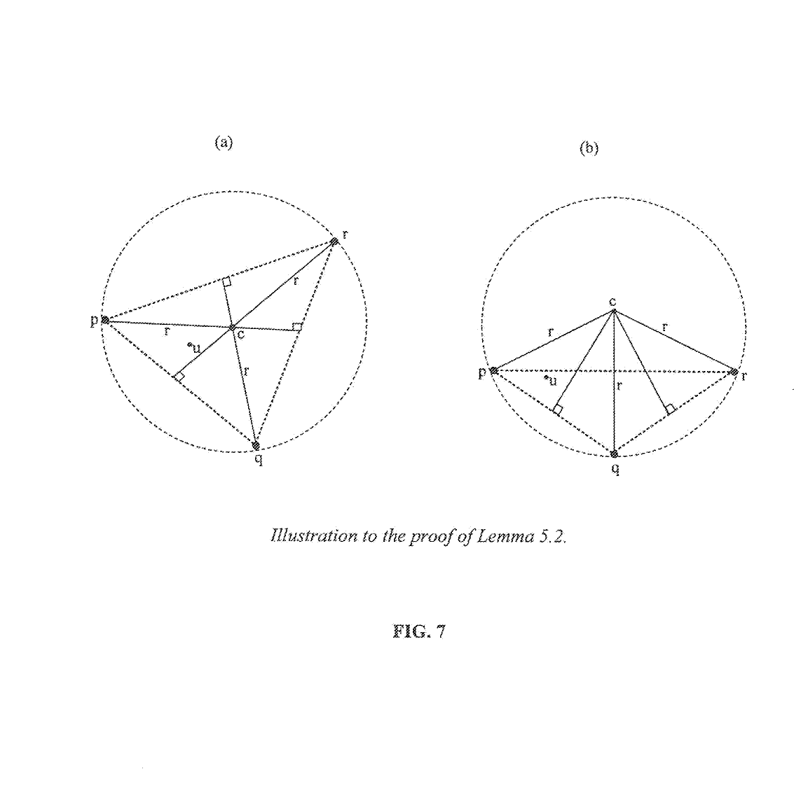

LEMMA 5.2. Given a triangle pqr with circumradius r and point u inside this triangle (see FIGS. 7a and 7b), the distance from u to the closest vertex of pqr is less than or equal to r.

By drawing the radial segments and perpendicular bisectors as shown on the figure, triangle pqr is covered by six or four triangles (depending on whether c is inside or outside of pqr) with common vertex c. Without loss of generality, suppose p is the vertex closest to u. Then by analyzing the right triangles incident upon p it is seen that lp−ul<r.

LEMMA 5.3 if v is a Typed vertex inserted (or considered for insertion and rejected) inside the selection ball of a d-simplex ξ (d=1, 2, 3) with circumradius equal to r then

R(v)≧δ_{d}r. (5.1)

by the Delaunay property and the encroachment rules, the circumball of ξ is empth, therefore the closest vertex to v has to be at a distance greater than or equal to δ_{d}r.

TABLE 5.1

| | Type of \hat{v} | | | | | |
|---|---|---|---|---|---|---|
| | Type-0 | Type-1 | Type-2 | | Type-3 | |
| Type of v | inserted | inserted | rejected | inserted | rejected | inserted |
| Type-1 | C_{3,1} | C_{3,1} | C_{2,1} | C_{3,1} | C_{2,1} | n/a |
| Type-2 | C_{3,2} | C_{3,2} | n/a | C_{3,2} | C_{2,2} | n/a |
| Type-3 | C_{1,3} | C_{1,3} | n/a | C_{1,3} | n/a | C_{1,3} |

All possible type combinations of a vertex v and its parent \hat{v} with the corresponding constants from Theorem 5.4. Vertices of Type-0 and Type-1 cannot be rejected by the algorithm and therefore the corresponding columns are not shown. For the child vertex v we do not distinguish between inserted and rejected cases because the analysis is the same.

### Then by Lemma 5.2,

∥proj(\hat{v})−p∥≦r, (5.7)

where r the circumradius of pqr. Since \hat{v} is inside the 3D circumball of triangle pqr,

∥\hat{v}−proj(\hat{v})∥<r, (5.8)

From (5.7) and (5.8), considering the right triangle with vertices \hat{v}, proj(\hat{v}), and p, we obtain that

### Therefore

$$\begin{matrix}R ( v ) \geq {δ}_{2} r & ( from Lemma 5.3 ) \\ > {δ}_{2} \frac{R ( \dot{v} )}{\sqrt{2}} , & ( from ( 5.9 ) ) ,\end{matrix}$$

and (5.2) with

$${C}_{2.2} = \frac{{δ}_{2}}{\sqrt{2}} .$$

To find C_{2.1}, note that \hat{v} is a rejected vertex of Type-2 or Type-3 that lies inside the circumball of the encroached segment containing v. Let this segment be pq. Then

$$\begin{matrix}R ( v ) \leq min \{ ‖ \hat{v} - p ‖ \cdot ‖ \hat{v} - q ‖ \} & \\ < \sqrt{2} r & \\ \leq \sqrt{2} \frac{R ( v )}{{δ}_{I}} & ( from Lemma 5.3 ) .\end{matrix}$$

Therefore, (5.2) holds with

$$\begin{matrix}{C}_{2 , 1} = \frac{{δ}_{1}}{\sqrt{2}} & \\ \geq {δ}_{3} \overline{p} l & ( from ( 5.5 ) ) \\ \geq {δ}_{3} \overline{p} R ( \dot{v} ) & ( from ( 5.6 ) ) ,\end{matrix}$$

and (5.2) holds with C_{1.3}=δ₃ ρ̅,

The constants C_{2, 2} and C_{2, 1} are established by considering the encroachment instances when v and \hat{v} either both lie in the same PLC facet, or \hat{v} does not lie on an element of the PLC. These constants are derived separately below.

To find C_{2, 2} let pqr be the encroached boundary triangle containing proj(\hat{v}) according to the Projection Lemma 5.1, see FIG. 3.1 (center). Without loss of generality, let p be the vertex of the triangle pqr which is closest to proj(\hat{v}),

$$\begin{matrix}lfs ( v ) \leq lfs ( c ) + ‖ v - c ‖ & ( from Lemma 2.3 ) \\ \leq ‖ c - \hat{v} ‖ + ‖ v - c ‖ & ( from ( 5.11 ) ) \\ < r + ‖ v - c ‖ & ( because \hat{v} encroaches upon \dot{ξ} ) \\ \leq r + ( 1 - {δ}_{d} ) r & ( since v lies in the selection ball of ξ ) \\ = ( 2 - {δ}_{d} ) r & \\ \leq ( 2 - {δ}_{d} ) \frac{R ( v )}{{δ}_{d}} & ( from ( 5.10 ) ) .\end{matrix}$$

To establish C_{3,d} (d=1,2), consider all the encroachment configurations when the encroaching point \tilde{v} lies on a facet or a segment that is not adjacent upon the facet or the segment containing v. In this case \hat{v} is an inserted (not rejected) vertex, and v is an originating vertex. Let be the encroached subsegment or triangular subface with center c and radius r which contains v. Two sub-cases exist, depending on whether or not \hat{v} is the vertex closest to v, since in a Delaunay triangulation every vertex is always connected with its closest neighbor.

(i) If \hat{v}is the vertex closest to v then R(v)=∥v−\hat{v}∥≧lfs(v).

(ii) Otherwise, let w be the vertex closest to v, which, by Delaunay property, has to lie outside the circumball. Then

R(v)=∥v−w∥≧δ_{d}^{r} (5.10)

Because circumcenter c of and \hat{v} lie on non-adjacent features, by Definition 2.2 of the lfs ( ) function,

lfs(c)≦∥c−\hat{v}∥, (5.11)

Therefore,

In both sub-cases,

$${C}_{3 , d} = \frac{{δ}_{d}}{2 - {δ}_{d}} ( d = 1.2 )$$

satisfy the inequality (5.3).

THEOREM 5.5, The GENERALIZED DELAUNAY REFINEMENT algorithm terminates.

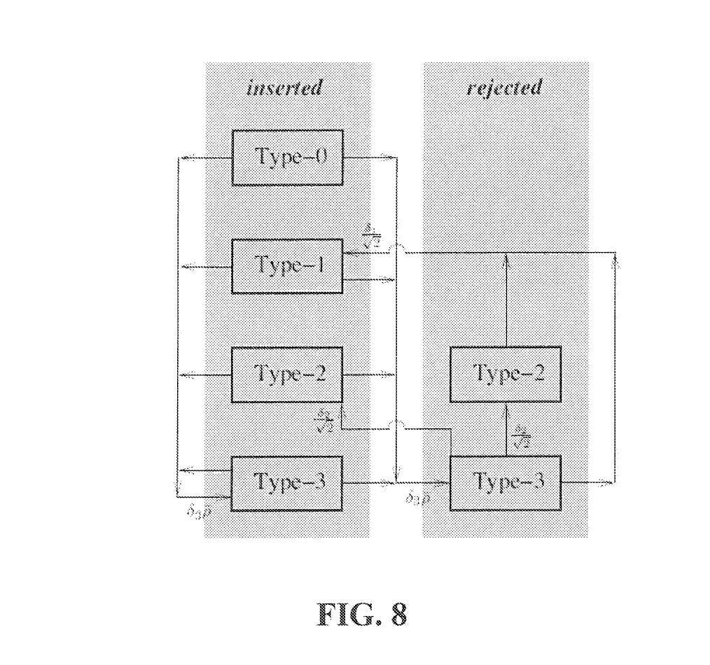

FIG. 8 shows the relationship between the insertion radius R(v) of a vertex v and the insertion radius R(\hat{v}) of its parent \hat{v} within a single parent sequence. All loops have a product of multipliers greater than or equal to one. Therefore, for each parent sequence the algorithm does not create edges shorter than R(vₘ) multiplied by a constant, where vₘ is the originating vertex of this sequence. From (5.3) R(vₘ) is lfs(vₘ) multiplied by a constant. Hence, the algorithm will not create edges shorter than a constant fraction of min_{v∈Ω} lfs(v) and will eventually terminate because the domain has a finite volume.

Proof of Good Grading. The quantity D(v) is defined as the ratio of lfs(v) over R(v) [21]:

$$D ( v ) = \frac{lfs ( v )}{R ( v )} . \qquad ( 6.1 )$$

It reflects the density of vertices near v at the time v is inserted, weighted by the local feature size. To achieve good mesh grading this density is made as small as possible. If the density is bounded from above by a constant, the mesh is said to have a good grading property.

LEMMA 6.1. If v is a Type-d (d=1, 2, 3) non-originating vertex of the mesh inserted by the GENERALIZED DELAUNAY REFINEMENT algorithm into the selection ball of a d-simplex ξ, and C_{n-d} are the constants specified by Theorem 5.4 for the corresponding cases listed in Table 5.1, then the following inequality holds:

The result follows from the division of both sides by R(v). □

THEOREM 6.2. There exist fixed constants Dᵢ>0, such that, for any vertex v of Type-i inserted (or considered for insertion and rejected) by the GDR algorithm with ρ̅>2, the following inequality holds:

D(v)≦Dᵢ, i=0, . . . 3. (6.4)

Therefore, the insertion radius of v has a lower bound proportional to its local feature size.

Proof. The proof is by induction. The base case covers originating vertices, and the inductive step covers non-originating vertices.

Base case: If v is an input vertex (Type-0), then all other input vertices must be at a distance of lfs(v) or greater, and therefore R(v)≧lfs(v) Then D(v)=lfs(v)/R(v)≦1, and the theorem holds with

D₀=1. (6.5)

The theorem is also true if v is a Type-1 or a Type-2 originating vertex (there are no Type-3 originating vertices) since from Theorem 5.4 (case n=3) D(v)=lfs(v)/R(v)≦1/C_{3,d}. Therefore, we can choose any D₁ and D₂ which satisfy in-equalities (6.6) and (6.7):

$$\begin{matrix}{D}_{1} \geq \frac{1}{{C}_{3 , 1}} , & ( 6.6 ) \\ {D}_{2} \geq \frac{1}{{C}_{3 , 2}} . & ( 6.7 )\end{matrix}$$

Inductive hypothesis: Assume that the theorem is true for any Type-j vertex \hat{v}, i.e., there exists a constant Dⱼ>0 such that

D(\hat{v})≦Dⱼ, j=0, . . . 3. (6.8)

Inductive step: Now we prove that under the base case and the inductive hypothesis the theorem also holds for any non-originating vertex v with parent \hat{v}. For the cases n=1 and n=2 from Table 5.1 (remember that for it n=3, v is an originating vertex), we start with (6.2) and apply the inductive hypothesis:

$$D ( v ) \leq {B}_{i} + \frac{D ( \hat{v} )}{{C}_{n , i}} \leq {B}_{i} + \frac{{D}_{j}}{{C}_{n , i}} , n = 1 , 2. \qquad ( 6.9 )$$

As a result, the inequalities in (6.4) can be satisfied if the constants D are chosen such that the following inequalities hold:

$${B}_{i} + \frac{{D}_{j}}{{C}_{n , i}} \leq {D}_{i} , n = 1 , 2. \qquad ( 6.10 )$$

Using Table 5.1, we expand the inequalities in (6.10) and obtain the following inequalities (6.11)-(6.17):

$$\begin{matrix}{B}_{3} + \frac{{D}_{0}}{{C}_{1 , 3}} \leq {D}_{3} , & ( 6.11 ) \\ {B}_{3} + \frac{{D}_{1}}{{C}_{1 , 3}} \leq {D}_{3} , & ( 6.12 ) \\ {B}_{3} + \frac{{D}_{2}}{{C}_{1 , 3}} \leq {D}_{3} , & ( 6.13 ) \\ {B}_{3} + \frac{{D}_{3}}{{C}_{1 , 3}} \leq {D}_{3} . & ( 6.14 ) \\ For n = 2 : & \\ {B}_{2} + \frac{{D}_{3}}{{C}_{2 , 2}} \leq {D}_{2} , & ( 6.15 ) \\ {B}_{1} + \frac{{D}_{2}}{{C}_{2 , 1}} \leq {D}_{1} , & ( 6.16 ) \\ {B}_{1} + \frac{{D}_{3}}{{C}_{2 , 1}} \leq {D}_{1} . & ( 6.17 )\end{matrix}$$

Now we have a system of recursive inequalities (6.6), (6.7) are (6.11)-6.17).

From (5.4) and (3.1) it follows that C_{1,3}=δ₃ ρ̅>2, therefore from (6.14) we can derive

$${D}_{3} \geq \frac{{C}_{1 , 3} {B}_{3}}{{C}_{1 , 3} - 1} . \qquad ( 6.18 )$$

From (5.4) and (3.1) it follows that C_{1,3}C_{2,1}>\sqrt{2}>1, therefore from (6.12) and (6.17) we can derive (6.19) and (6.20):

$$\begin{matrix}{D}_{1} \geq \frac{{C}_{1 , 3} ( {B}_{3} + {C}_{2 , 1} {B}_{1} )}{{C}_{1 , 3} {C}_{2 , 1} - 1} , & ( 6.19 ) \\ {D}_{3} \geq \frac{{C}_{2 , 1} ( {B}_{1} + {C}_{1 , 3} {B}_{3} )}{{C}_{1 , 3} {C}_{2 , 1} - 1} . & ( 6.20 )\end{matrix}$$

From (5.4) and (3.1) it follows that C_{1,3}C_{2,2}>\sqrt{2}>1, therefore from (6.13) and (6.15) we can derive (6.21) and (6.22):

$$\begin{matrix}{D}_{2} \geq \frac{{C}_{1 , 3} ( {B}_{3} + {C}_{2 , 2} {B}_{2} )}{{C}_{1 , 3} {C}_{2 , 2} - 1} , & ( 6.21 ) \\ {D}_{3} \geq \frac{{C}_{2 , 2} ( {B}_{2} + {C}_{1 , 3} {B}_{3} )}{{C}_{1 , 3} {C}_{2 , 2} - 1} . & ( 6.22 )\end{matrix}$$

From (5.4) and (3.1), nothing that ρ̅>2, it follows that C_{1,3}C_{2,1}C_{2,2}>1, therefore from (6.12), (6.16), and (6.15) we can derive (6.23)-(6.25):

$$\begin{matrix}{D}_{1} \geq \frac{{C}_{1 , 3} ( {B}_{3} + {C}_{2 , 2} ( {B}_{2} + {C}_{2 , 1} {B}_{1} ) )}{{C}_{1 , 3} {C}_{2 , 1} {C}_{2 , 2} - 1} , & ( 6.23 ) \\ {D}_{2} \geq \frac{{C}_{2 , 1} ( {B}_{1} + {C}_{1 , 3} ( {B}_{3} + {C}_{2 , 2} {B}_{2} ) )}{{C}_{1 , 3} {C}_{2 , 1} {C}_{2 , 2} - 1} , & ( 6.24 ) \\ {D}_{3} \geq \frac{{C}_{2 , 2} ( {B}_{2} + {C}_{2 , 1} ( {B}_{1} + {C}_{1 , 3} {B}_{3} ) )}{{C}_{1 , 3} {C}_{2 , 1} {C}_{2 , 2} - 1} . & ( 6.25 )\end{matrix}$$

Considering (6.6), (6.19), and (6.23) we can choose D₁ as follows:

$${D}_{1} = max \{ \frac{1}{{C}_{3 , 1}} , \frac{{C}_{1 , 3} ( {B}_{2} + {C}_{2 , 1} {B}_{1} )}{{C}_{1 , 2} {C}_{2 , 1} - 1} , \frac{{C}_{1 , 3} ( {B}_{2} + {C}_{2 , 2} ( {B}_{2} + {C}_{2 , 1} {B}_{2} ) )}{{C}_{1 , 3} {C}_{2 , 1} {C}_{2 , 2} - 1} \} . \qquad ( 6.26 )$$

Considering (6.7), (6.21), and (6.24) we can choose D₂ as follows:

$${D}_{2} = max \{ \frac{1}{{C}_{2 , 2}} , \frac{{C}_{1 , 3} ( {B}_{3} + {C}_{2 , 2} {B}_{2} )}{{C}_{1 , 3} {C}_{2 , 2} - 1} , \frac{{C}_{2 , 1} ( {B}_{2} + {C}_{1 , 3} ( {B}_{3} + {C}_{2 , 2} {B}_{2} ) )}{{C}_{1 , 3} {C}_{2 , 1} {C}_{2 , 3} - 1} \} . \qquad ( 6.27 )$$

Considering (6.11), (6.18), (6.20), (6.22), and (6.25) we can choose D₃ as follows:

$${D}_{3} = max \{ {B}_{3} + \frac{1}{{C}_{1 , 3}} , \frac{{C}_{1 , 3} {B}_{3}}{{C}_{1 , 3} - 1} , \frac{{C}_{2 , 1} ( {B}_{1} {C}_{1 , 3} {B}_{3} )}{{C}_{1 , 2} {C}_{3 , 1} - 1} , \frac{{C}_{2 , 2} ( {B}_{3} + {C}_{1 , 3} {B}_{2} )}{{C}_{1 , 3} {C}_{2 , 2} - 1} , \frac{{C}_{2 , 2} ( {B}_{2} {C}_{2 , 1} ( {B}_{1} {C}_{1 , 3} {B}_{2} ) )}{{C}_{1 , 3} {C}_{2 , 1} {C}_{2 , 2} - 1} \} . \qquad ( 6.28 )$$

By plugging in the expressions for B and C we get:

$$\begin{matrix}{D}_{1} = max \{ \frac{2 - {δ}_{1}}{{δ}_{1}} , \frac{( \sqrt{2} ( 2 - {δ}_{3} ) + ( 2 - {δ}_{1} ) {δ}_{3} ) \overline{ρ}}{{δ}_{1} {δ}_{3} \overline{ρ} - 2} , \frac{( 2 ( 2 - {δ}_{2} ) + \sqrt{2} ( 2 - {δ}_{2} ) {δ}_{3} + ( 2 - {δ}_{1} ) {δ}_{2} {δ}_{3} ) \overline{ρ}}{{δ}_{1} {δ}_{2} {δ}_{3} \overline{ρ} - 2} \} , & ( 6.29 ) \\ {D}_{2} = max \{ \frac{2 - {δ}_{2}}{{δ}_{2}} , \frac{( \sqrt{2} ( 2 - {δ}_{3} ) + ( 2 - {δ}_{2} ) {δ}_{3} ) \overline{ρ}}{{δ}_{2} {δ}_{3} \overline{ρ} - \sqrt{2}} , \frac{\sqrt{2} ( 2 - {δ}_{1} ) + ( \sqrt{2} {δ}_{1} ( 2 - {δ}_{3} ) + {δ}_{1} ( 2 - {δ}_{2} ) {δ}_{3} ) \overline{ρ}}{{δ}_{1} {δ}_{2} {δ}_{3} \overline{ρ} - 2} \} , & ( 6.30 ) \\ {D}_{3} = max \{ \frac{1 + ( 2 - {δ}_{3} ) \overline{ρ}}{{δ}_{3} \overline{ρ}} , \frac{( 2 - {δ}_{3} ) \overline{ρ}}{{δ}_{3} \overline{ρ} - 1} , \frac{2 - {δ}_{1} + {δ}_{2} {δ}_{3} \overline{ρ}}{{δ}_{1} {δ}_{3} \overline{ρ} - \sqrt{2}} , \frac{2 - {δ}_{2} + {δ}_{2} ( 2 - {δ}_{3} ) \overline{ρ}}{{δ}_{2} {δ}_{3} \overline{ρ} - \sqrt{2}} , \frac{\sqrt{2} ( 2 - {δ}_{2} ) + ( 2 - {δ}_{1} ) {δ}_{2} + {δ}_{1} {δ}_{2} ( 2 - {δ}_{3} ) \overline{ρ}}{{δ}_{1} {δ}_{2} {δ}_{3} \overline{ρ} - 2} \} . & ( 6.31 )\end{matrix}$$

Using inequalities (3.1), we find the maximum values in (6.29), (6.30), and (6.31):

$$\begin{matrix}{D}_{1} = \frac{( 2 ( 2 - {δ}_{3} ) + \sqrt{2} ( 2 - {δ}_{2} ) {δ}_{3} + ( 2 - {δ}_{1} ) {δ}_{2} {δ}_{3} ) \overline{ρ}}{{δ}_{1} {δ}_{2} {δ}_{3} \overline{ρ} - 2} , & ( 6.32 ) \\ {D}_{2} = \frac{\sqrt{2} ( 2 - {δ}_{1} ) + ( \sqrt{2} {δ}_{1} ( 2 - {δ}_{3} ) + {δ}_{1} ( 2 - {δ}_{2} ) {δ}_{3} ) \overline{ρ}}{{δ}_{1} {δ}_{2} {δ}_{3} \overline{ρ} - 2} , & ( 6.33 ) \\ {D}_{3} = \frac{\sqrt{2} ( 2 - {δ}_{2} ) + ( 2 - {δ}_{1} ) {δ}_{2} + {δ}_{1} {δ}_{2} ( 2 - {δ}_{3} ) \overline{ρ}}{{δ}_{1} {δ}_{2} {δ}_{3} \overline{ρ} - 2} . & ( 6.34 )\end{matrix}$$

By examining the expressions for D₁, D₂, and D₃, we also note that D₁>D₂>D₃ for all admissible values of δ₁, δ₂, δ₃, and ρ̅. Indeed, denoting for convenience

$${D}_{1} - {D}_{2} = \frac{N}{{δ}_{1} {δ}_{2} {δ}_{3} \overline{ρ} - 2} ,$$

we have

$$\begin{matrix}N = ( 2 ( 2 - {δ}_{3} ) + \sqrt{2} ( 2 - {δ}_{2} ) {δ}_{3} + ( 2 - {δ}_{1} ) {δ}_{2} {δ}_{3} ) \overline{ρ} - & \\ \sqrt{2} ( 2 - {δ}_{1} ) - ( \sqrt{2} {δ}_{1} ( 2 - {δ}_{3} ) + {δ}_{1} ( 2 - {δ}_{2} ) {δ}_{3} ) \overline{ρ} & \\ = 4 \overline{ρ} + 2 ( \sqrt{2} - 1 ) {δ}_{3} \overline{ρ} + ( 2 - \sqrt{2} ) {δ}_{2} {δ}_{3} \overline{ρ} - & \\ 2 \sqrt{2} - {δ}_{1} ( ( 2 \sqrt{2} + ( 2 - \sqrt{2} ) {δ}_{3} ) \overline{ρ} - \sqrt{2} ) & \\ \geq 1 \overline{ρ} + 2 ( \sqrt{2} - 1 ) {δ}_{3} \overline{ρ} + 2 ( 2 - \sqrt{2} ) - & ( using ( 3.1 ) ) \\ 2 \sqrt{2} - ( ( 2 \sqrt{2} + ( 2 - \sqrt{2} ) {δ}_{3} ) \overline{ρ} - \sqrt{2} ) & \\ > 0 & ( since \overline{ρ} > 2 ) , \end{matrix}$$

and therefore D₁>D₂. Similarly it can be shown that D₂>D₃. In other words, grading is always better (in the worst case analysis) in the interior of the domain that on the boundaries.

In Table 6.1 list the values of D₁, D₂, and D₃ corresponding to a few values of parameters δ₁, δ₂, δ₃, and ρ̅. As expected, grading becomes worse with the increase in the size of the selection balls. This follows from the fact that larger selection balls allow for shorter mesh edges. Also, an increase in size of one type of selection balls leads to an increase of all grading constants, which is due to the involvement of parent points in the grading analysis.

TABLE 6.1
Several sample values of algorithm parameters and
the corresponding grading constants.

| ρ̅ | δ₁ | δ₂ | δ₃ | D₁ | D₂ | D₃ |
|---|---|---|---|---|---|---|
| 2.1 | 1.0 | 1.0 | 1.0 | 92.70 | 64.84 | 45.14 |
| 2.5 | 1.0 | 1.0 | 1.0 | 22.07 | 14.90 | 9.83 |
| 3.0 | 1.0 | 1.0 | 1.0 | 13.24 | 8.66 | 5.41 |
| 3.0 | 1.0 | 1.0 | 0.9 | 18.74 | 12.54 | 8.16 |
| 3.0 | 1.0 | 1.0 | 0.8 | 32.49 | 22.26 | 15.04 |
| 3.0 | 1.0 | 1.0 | 0.7 | 128.70 | 90.30 | 63.14 |
| 3.0 | 1.0 | 0.9 | 1.0 | 19.10 | 12.80 | 7.37 |
| 3.0 | 1.0 | 0.9 | 0.9 | 30.77 | 21.05 | 12.62 |
| 3.0 | 1.0 | 0.9 | 0.8 | 81.83 | 57.16 | 35.60 |
| 3.0 | 1.0 | 0.8 | 1.0 | 33.73 | 23.14 | 12.24 |
| 3.0 | 1.0 | 0.8 | 0.9 | 83.39 | 58.26 | 32.11 |
| 3.0 | 1.0 | 0.7 | 1.0 | 136.15 | 95.57 | 46.38 |
| 3.0 | 0.9 | 1.0 | 1.0 | 19.35 | 11.53 | 7.45 |
| 3.0 | 0.9 | 1.0 | 0.9 | 31.14 | 19.04 | 12.75 |
| 3.0 | 0.9 | 1.0 | 0.8 | 82.71 | 51.86 | 35.96 |
| 3.0 | 0.9 | 0.9 | 1.0 | 31.71 | 19.40 | 11.57 |
| 3.0 | 0.9 | 0.9 | 0.9 | 72.05 | 45.07 | 27.91 |
| 3.0 | 0.9 | 0.8 | 1.0 | 82.82 | 53.84 | 29.61 |
| 3.0 | 0.8 | 1.0 | 1.0 | 34.61 | 18.73 | 12.54 |
| 3.0 | 0.8 | 1.0 | 0.9 | 85.36 | 47.44 | 32.84 |
| 3.0 | 0.8 | 0.9 | 1.0 | 86.92 | 48.32 | 29.97 |
| 3.0 | 0.7 | 1.0 | 1.0 | 141.43 | 69.08 | 48.14 |
| 4.0 | 1.0 | 1.0 | 1.0 | 8.83 | 5.54 | 3.21 |
| 8.0 | 1.0 | 1.0 | 1.0 | 5.89 | 3.45 | 1.74 |
| 16.0 | 1.0 | 1.0 | 1.0 | 5.04 | 2.86 | 1.32 |
| 16.1 | 0.5 | 0.5 | 0.5 | 5713.13 | 2018.84 | 712.71 |
| 32.0 | 1.0 | 1.0 | 1.0 | 4.71 | 2.62 | 1.15 |
| 32.0 | 0.5 | 0.5 | 0.5 | 70.97 | 24.03 | 7.44 |

Disclosed is a novel generalized three-dimensional guaranteed quality Delaunay refinement algorithm and proved its termination, as well as fidelity and good grading of the resulting mesh. The presented algorithm and analysis extend the previous approaches by introducing a sequence of three types of insertion regions, corresponding to the points inserted on the domain features of each dimensionality. The sizes of the regions can be chosen for each instantiation of the algorithm, based on its requirements with respect to the grading-flexibility tradeoff. The proposed selection balls could offer the flexibility and a unified theoretical framework to insert points in a variety of positions dictated by various Delaunay-based mesh optimizations techniques such as the following:

avoiding slivers by inserting points in the neighborhoods of circumcenters [7,11],

reducing the final mesh size by picking specific “off-center” positions [23],

creating a hierarchy of nested meshes [18] by choosing points on the existing mesh edges [17].

### REFERENCES

The following references, as referred to throughout the disclosure, are each incorporated by reference in their entirety herein.

[1] MARSHALL WAYNE BERN, DAVID EPPSTEIN, AND JOHN RUSSELL GILBERT, Provably good mesh generation, J. Computer & Systems Sciences, 48 (1994), pp. 384-409. Special issue for 31st FOCS.

[2] ADRIAN BOWYER, Computing Dirichlet tesselations, Computer Journal, 24 (1981), pp. 162-166.

[3] ANDREY N. CHERNIKOV AND NIKOS P. CHRISOCHOIDES, Three-dimensional semi-generalized point placement method for Delaunay mesh refinement, in Proceedings of the 16th International Meshing Roundtable, Seattle, Wash., October 2007, Springer, pp. 25-44.

[4] Three-dimensional Delaunay refinement for multi-core processors, in Proceedings of the 22nd Annual International Conference on Supercomputing, Island of Kos, Greece, 2008, ACM Press, pp. 214-224.

[5] Generalized two-dimensional Delaunay mesh refinement, SIAM Journal on Scientific Computing, 31 (2009), pp. 3387-3403.

[6] L. PAUL CHEW, Guaranteed-quality triangular meshes, Tech. Report TR89983, Cornell University, Computer Science Department, 1989.

[7] Guaranteed-quality Delaunay meshing in 3D, in Proceedings of the 13th ACM Symposium on Computational Geometry, Nice, France, 1997, pp. 391-393.

[8] PANAGIOTIS A. FOTEINOS, ANDREY N. CHERNIKOV, AND NIKOS P. CHRISOCHOIDES, Fully generalized two-dimensional constrained Delaunay mesh refinement, SIAM Journal on Scientific Computing, 32 (2010), pp. 2659-2686.

[9] PAUL-LOUIS GEORGE AND HOUMAN BOROUCHAKI, Delaunay Triangulation and Meshing. Application to Finite Elements, HERMES, 1998.

[10] XIANG-YANG LI, Generating well-shaped d-dimensional Delaunay meshes, Theoretical Computer Science, 296 (2003), pp. 145-165.

[11] XIANG-YANG LI AND SHANG-HUA TENG, Generating well-shaped Delaunay meshes in 3D, in Proceedings of the 12th annual ACM-SIAM symposium on Discrete algorithms, Washington, D.C., 2001, pp. 28-37.

[12] GARY L. MILLER, STEVEN E. PAV, AND NOEL WALKINGTON, When and why Delaunay refinement algorithms work, Int. J. Comput. Geometry Appl., 15 (2005), pp. 25-54.

[13] GARY L. MILLER, DAFNA TALMOR, SHANG-HUA TENG, AND NOEL WALKINGTON, A Delaunay based numerical method for three dimensions: Generation, formulation, and partition, in Proceedings of the 27th Annual ACM Symposium on Theory of Computing, Las Vegas, Nev., May 1995, pp. 683-692.

[14] GARY L. MILLER, DAFNA TALMOR, SHANG-HUA TENG, NOEL WALKINGTON, AND HAN WANG, Control volume meshes using sphere packing: Generation, refinement and coarsening, in Proceedings of the 5th International Meshing Roundtable, Pittsburgh, Pa., October 1996, pp. 47-61.

[15] SCOTT A. MITCHELL AND STEPHEN A. VAVASIS, Quality mesh generation in higher dimensions, SIAM Journal for Computing, 29 (2000), pp. 1334-1370.

[16] ALEXANDER RAND AND NOEL WALKINGTON. Collars and intestines: Practical conforming Delaunay refinement, in Proceedings of the 18th International Meshing Roundtable, 2009, pp. 481-497.

[17] MARIA-CECILIA RIVARA, A study on Delaunay terminal edge method, in Proceedings of the 15th International Meshing Roundtable, Birmingham, Ala., September 2006, Springer, pp. 543-562.

[18] ULRICH RUDE, Mathematical and Computational Techniques for Multilevel Adaptive Methods, Frontiers in Applied Mathematics, SIAM, 1993.

[19] JIM RUPPERT, A Delaunay refinement algorithm for quality 2-dimensional mesh generation, Journal of Algorithms, 18(3) (1995), pp. 548-585.

[20] JONATHAN RICHARD SHEWCHUK, Delaunay Refinement Mesh Generation, PhD thesis, Carnegie Mellon University, 1997.

[21] Tetrahedral mesh generation by Delaunay refinement, in Proceedings of the 14th ACM Symposium on Computational Geometry, Minneapolis, Minn., 1998, pp. 86-95.

[22] HANG SI, An analysis of Shewchuk's Delaunay refinement algorithm, in Proceedings of the 18th International Meshing Roundtable, Salt Lake City, Utah, October 2009, Springer, pp. 499-518.

[23] ALPER UNGöR, Off-centers A new type of Steiner points for computing size-optimal guaranteed-quality Delaunay triangulations, in Proceedings of LATIN, Buenos Aires, Argentina, April 2004, pp. 152-161.

[24] DAVID F. WATSON, Computing the n-dimensional Delaunay tesselation with application to Voronoi polytopes, Computer Journal, 24 (1981), pp. 167-172.

While the invention has been described and illustrated with reference to certain preferred embodiments herein, other embodiments are possible. Additionally, as such, the foregoing illustrative embodiments, examples, features, advantages, and attendant advantages are not meant to be limiting of the present invention, as the invention may be practiced according to various alternative embodiments, as well as without necessarily providing, for example, one or more of the features, advantages, and attendant advantages that may be provided by the foregoing illustrative embodiments.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

Accordingly, while the invention has been described and illustrated in connection with preferred embodiments, many variations and modifications as will be evident to those skilled in this art may be made without departing from the scope of the invention, and the invention is thus not to be limited to the precise details of methodology or construction set forth above, as such variations and modification are intended to be included within the scope of the invention. Therefore, the scope of the appended claims should not be limited to the description and illustrations of the embodiments contained herein.

What is claimed is:

1. A method for generating and refining meshes for a three-dimensional domain, comprising:
generating a initial Delaunay mesh;
identifying selection balls whose radius-edge ratio is greater than an upper bound value; and
refining the generated Delaunay mesh by inserting points within the selection balls to reduce the radius-edge ratios of all tetrahedra in the mesh below a given upper bound value,
wherein selection balls include one-dimensional selection balls, two-dimensional selection balls, and three-dimensional selection balls,
wherein the selection balls of a lower dimension are refined before the selection balls of a higher dimension are refined.

2. The method according to claim 1, where the radii of the selection balls are defined by a first value for the one-dimensional selection ball, a second value for the two-dimensional selection ball, and a third value for the three-dimensional selection ball.

3. The method according to claim 1, wherein the product of the first value, the second value, and the third value is greater than one to ensure a termination of the refining process.

4. A recording medium storing a program that instructs a computer to generate and refine meshes for a three-dimensional domain, the program comprising:
generating a initial Delaunay mesh;
identifying tetrahedra whose radius-edge ratio is greater than an upper bound value; and
refining the generated Delaunay mesh by inserting points within the selection balls to reduce the radius-edge ratios of all tetrahedra below a given upper bound value,
wherein selection balls include one-dimensional selection balls, two-dimensional selection balls, and three-dimensional selection balls.
wherein the selection balls of a lower dimension are refined before the selection balls of a higher dimension are refined.

5. The recording medium according to claim 4, where the predetermined amounts include a first value for a one-dimensional reduction, a second value for a two-dimensional reduction, and a third value for a three-dimensional reduction.

6. The recording medium according to claim 4, wherein the product of the first value, the second value, and the third value is greater than a predetermined ratio to ensure a termination of the refining process.
